(19) United States
(12) Patent Application Publication
(10) Pub. No.: US 2006/0062116 A1
(43) Pub. Date: Mar. 23, 2006

(54) Optical data link capable of compensating tracking error

(76) Inventor: Hiroto Ishibashi, Yokohama-shi (JP)

Correspondence Address: SMITH, GAMBRELL & RUSSELL, LLP, 1850 M STREET, N.W., SUITE 800, WASHINGTON, DC, 20036, US

(21) Appl. No.: 11/218,733

(22) Filed: Sep. 6, 2005

(30) Foreign Application Priority Data
Sep. 7, 2004 (JP) P. 2004-260165

(51) Int. Cl. G11B 20/10; G11B 5/58

(52) U.S. Cl. 369/47.35; 369/53.1; 369/47.5

(57) ABSTRACT

The present invention provides an optical data link capable of compensating the fluctuation due to the tracking error. The data link of the invention provides a look-up-table in which a plurality of control data, such as the bias and modulation current and the loop gain of the auto-power-control loop to make the average power and the extinction ratio of the optical output from the data link, not from the laser diode within the data link constant in the preset values, is stored in connection to temperatures. During the operation, the controller within the data link reads out these data to control the laser diode.

### FIELD OF THE INVENTION

The present invention relates to an optical data link, in particular, the optical data link having a digitally controlled optical transmitting module.

### RELATED PRIOR ART

In general, the optical transmitting module, a semiconductor laser diode (LD) in the optical transmitting module is controlled in an optical output thereof by an automatic power control (APC). A photodiode (PD) monitors the optical output from the LD and the bias and modulation currents supplied to the LD is controlled so as to maintain the optical output thereof constant based on a signal output from the PD. Such technique has been disclosed, for example Japanese patent application published as 2003-218460.

A recent optical data link usually provides a function to communicate with the host system, in which the host system may read out the information that relates to the operation of the data link including the optical output power of the LD therefrom, which has been ruled in, for example, a multi source agreement (MSA) for the SFF-transceiver (SFF-8472 Specification for Diagnostic Monitoring Interface for Optical Xcvrs Rev. 9.5 <URL: ftp://ftp.Seagate.com/sff/SFF-8472.PDF>.

On the other hand, the optical output from the data link is extracted through an optical coupling system that connects the LD to an optical connector provided in the data link. The conventional APC loop using the PD is primarily based on the optical output from the LD, not through the optical coupling system, to adjust the bias and modulation currents for the LD. Since the optical coupling system shows the temperature dependence in the coupling efficiency thereof, primarily due to a positional deviation of the optical elements in the coupling system, the magnitude of the optical output from the data link may change as the temperature of the data link changes. Accordingly, even the APC loop keeps the optical output of the LD constant, the optical output from the data link via the coupling system fluctuates as the temperature changes. This phenomenon is called as the tracking error. The present invention is to provide an optical data link that overcomes the tracking error.

### SUMMARY OF THE INVENTION

One aspect of the present invention relates to a method for controlling an optical output of an optical data link. The data link comprises an LD, an optical coupling system, a PD, and a controller. The coupling system guides light emitted from the laser diode to an outside of the optical data link. The photodiode monitors the light of the laser diode. The controller, constituting the APC loop cooperating with the LD and the PD, provides a control look-up-table (LUT) in which information to make the average power and the extinction ratio of the optical output from the data link, not the light emitted from the LD, constant and another information to adjust the loop gain of the APC. This information is stored within the controller in connection with temperatures of the data link.

The method according to the invention comprises steps of: (a) setting a target temperature in the controller, (b) reading information from the LUT to make the average power and the extinction ratio of the output from the data link constant, and setting current supplied to the LD based on this information, (c) reading another information to adjust the loop gain and setting the loop gain based on the another information, and (d) starting the APC loop.

Since the controller first sets the bias and modulation currents such that the average power and the extinction ratio of the optical output from the data link are maintained, and secondly sets the loop gain of the APC loop, the tracking error can be cancelled. The APC loop may includes steps of: (i) comparing the average power of the light emitted from the LD with a reference value, (ii) revising the target temperature by adding a temperature difference obtained by multiplying a specific coefficient by this comparison result to the present target temperature, (iii) reading new information form the LUT in connection with the revised target temperature, and (iv) setting new current condition to the LD. A new set of the information to make the average power and the extinction ratio of the optical output from the data link constant is always read out from the LUT during the APC operation. Accordingly, the present data link may cancel the tracking error even when the average power of the light emitted from the laser diode changes.

Even when the LUT provides the information in connection with sparse temperatures and the new target temperature does not match the temperatures saved within the LUT, the controller may interpolate or extrapolate the information and may obtain the new set of information corresponding to the new target temperature. Accordingly, the controller is unnecessary to provide a large size of the LUT.

The loop gain of the APC loop may be adjusted by setting the conversion efficiency of the photodiode. The photodiode generates a photocurrent corresponding to the average power of the light emitted from the LD, and converts this photocurrent into a voltage signal. The loop gain of the APC loop may be adjusted by changing this conversion efficiency from the photo current into the voltage signal. The PD may provide a load resistor connected in serial thereto. The photocurrent may flow in this load resistor. Therefore, to change the resistance of this load resistor may change the conversion efficiency of the PD.

Another aspect of the present invention relates to a method for manufacturing the optical data link. The method may comprise: (a) shutting the APC loop off and setting an ambient temperature of the data link to a preset temperature, (b) setting the bias and modulation currents for the LD such that the optical output from the data link shows a predetermined average power and a predetermined extinction ratio, (c) setting the conversion ratio of the PD to match the average power of the light directly from the LD with a reference value; (d) iterating the processes (b) and (c) as changing the preset temperature; and (e) creating the LUT by arranging the bias and modulation currents and the conversion ratio against the preset temperatures.

The present method for manufacturing the data link, the optical output from the data link via the optical coupling system, not directly from the LD, are monitored and the bias and modulation currents are adjusted to make the average power and the extinction ratio of the optical output constant. Accordingly, the bias and modulation currents thus obtained compensate the tracking error.

When the preset temperatures are sparse, the extrapolation or the interpolation of the bias and modulation currents and the conversion ratio may create a plurality of new set of data with a dense interval of temperatures.

Still another aspect of the present invention relates to an optical data link. The data link comprises a LD, a PD, an optical coupling system, and a controller. The coupling system guides the light emitted from the LD to an outside of the data link, and may include a condenser lens. The coupling system may cause the tracking error because the optical coupling efficiency between the LD and an optical connector, provided in the data link to extract the light therefrom, that constitute the coupling system fluctuates as the temperature varies due to a positional deviation of members including the coupling system. The controller, which constitutes the APC loop cooperating with the LD and the PD, includes the LUT that saves a plurality of paired data of bias and modulation currents and a plurality of information relating to the APC loop in connection with temperatures. The paired bias and modulation currents are decided such that the average power and the extinction ratio of the optical output from the data link constant, while the APC loop information adjusts the loop gain thereof.

The paired data of the bias and modulation currents is determined to make the average power and the extinction ratio of the optical output from the data link constant, not from the LD. Accordingly, the tracking error caused by the positional deviation due to the temperature varying of the optical coupling system may be cancelled. The present invention may be applicable no matter what the optical coupling system is constituted.

Other features and advantages of the present invention will be apparent from the accompanying drawings and from the detailed description that follows below.

### BRIEF DESCRIPTION OF DRAWINGS

FIG. 1 is a schematic diagram showing the optical data link according to the present invention;

FIG. 2 explains the structure of the look-up-table (LUT) storing the bias and modulation levels;

FIG. 3 explains the structure of the LUT storing the resistance of the variable resistor;

FIG. 4 schematically shows the testing of the data link at the factory; and

FIG. 5 is a flow chart for the testing of the data link.

### DETAILED DESCRIPTION OF PREFERRED EMBODIMENTS

Next, preferred embodiments of the present invention will be described as referring to accompanying drawings. In the explanation of drawings and in the specification, the same symbols or numerals will refer to the same element without overlapping explanations.

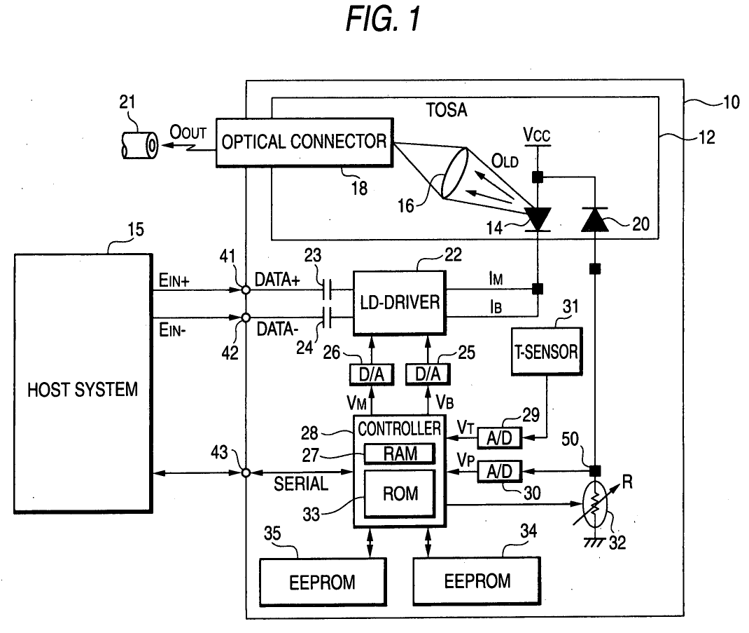

FIG. 1 is a schematic diagram of an optical data link 10 according to the present invention. As shown in FIG. 1, the data link 10 configures to be connected with the host system 15. The data link 10 provides input terminals, 41 and 42, to receive signals therein from the host system 15. These terminals, 41 and 42, receive signals, E_{IN+} and E_{IN-}, which are complementary to each other.

The data link 10 provides a transmitting optical subassembly (hereinafter denoted as TOSA) 12 that outputs light O_{OUT} to the outside of the data link 10 and includes a laser diode 14 (LD), an optical coupling system 16, an optical connector 18, and a photodiode (PD).

The LD 14 optically couples with the optical connector via the coupling system 18. The light O_{LD} emitted from the LD, probably from a front facet of the LD, couples with the optical connected 18 via the coupling system 16, and outputs to the outside from the optical connector 18 as an optical output O_{OUT}. The optical connector 18 operates as an optical output port of the data link 18, and the coupling system guides the light emitted from the LD 14 to this output port. Mating an optical plug provided in a tip of an external optical fiber, the optical output O_{OUT} may be transmitted in the optical communication system via the optical fiber 21.

Both the anode of the LD 14 and the cathode of the PD 20 are connected to a power supply Vcc. The power supply Vcc biases the LD 14 in forward, while biases the PD 20 in reverse. The PD 20 detects light emitted from the LD 14, generally the light emitted from the rear facet of the LD 14 when the LD 14 is an edge-emitting type, and generates a photo current corresponding to the magnitude of the monitored light, which generally correlates with the front facet light O_{LD}. Since the response of the PD 20 used in the TOSA 12 is generally inferior to that of the LD 14, the PD 20 outputs the photo current corresponding to an average of the light O_{LD}.

The cathode of the LD 14 connects to a driver 22, which is called as an LD-Driver. The LD-Driver 22, receiving the complementary signals, E_{IN+}and E_{IN-}, drives the LD 14 to output the light O_{LD} to follow this complementary data. The LD-Driver 22 provides a bias current I_{B}, which is a DC current, and a modulation current I_{M} to the LD 14. The modulation current I_{M} is modulated by the complementary signals, E_{IN+} and E_{IN-}, received via respective coupling capacitors, 23 and 24. The LD-Driver 22 superposes this modulation current I_{M} with the bias current I_{B}, and provides thus merged currents to the LD 14. The LD 14 is driven by these bias current I_{B} and modulation current I_{M}, and output the signal light O_{LD} modulated by the modulation current I_{M}.

The LD-Drive 22 connects to the controller 28 via two digital-to-analog converters (hereinafter denoted as the D/A-C), 25 and 26. The controller 28 stabilizes the optical output O_{LD} of the LD 14 by carrying out the APC. The APC compares the optical output O_{LD} monitored by the PD 20 with a reference, and adjusts the bias and modulation currents, I_{B} and I_{M}, depending on this comparison. The controller 28 sets analogue signals corresponding to the bias I_{B} and modulation currents I_{M}in the LD-Driver 22 via two D/A-Cs, 25 and 26. The LD-Driver 22 adjusts the magnitude of the currents, I_{B} and I_{M}, as responding these signals from the controller 28.

The controller 28 connects a temperature sensor 31, which is typically a thermistor, to monitor an internal temperature of the data link 10. The internal temperature reflects or corresponds to the temperature of the LD 14. The temperature sensor generates an analog signal corresponding to this internal temperature and sends the sensed signal to the controller 28 via the A/D-C 29. The A/D-C 29 converts this analog signal into a digital value V_{T}, which will be called as a temperature-monitor signal.

The controller 28 further connects a variable resistor 32 via an A/D-C 30. The variable resistor 32 is put between the anode of the PD 20 and the ground. The controller 28 may adjust the resistance of this variable resistor 32.

The photo current generated by the PD 20 flows in the variable resistor 32 and causes a voltage drop depending on the resistance R of the variable resistor 32. Thus, this voltage drop reflects the photo current from the PD 20. The variable resistor 32 operates as a load resistor for the PD 20. As described later, the resistance R of the variable resistor 32 is adjusted by the controller 28 based on the LUT 54 created within the non-volatile memory in the controller.

The A/D-C 30 connects to a node 50 between the PD 20 and the resistor 32. The A/D-C 30 converts the analog signal thus caused in the resistor 32 into a corresponding digital value V_{P} to output to the controller 28. The signal V_{P} reflects the photo current from the PD 20 and, consequently, corresponds to the optical output O_{LD} from the LD 14. The V_{P} will be called as a power-monitor signal.

The controller 28 carries out the APC based on this power-monitor signal V_{P}. That is, the LD 14, the PD 20, the resistor 32, the controller 28, and the LD-Driver 22 constitutes a feedback loop, by which the output power from the LD 14 is controlled based on the power-monitor signal V_{P} from the PD 20 with a variable loop gain determined by the resistance R of the resistor 32. The resistance R or the variable resistor 32 may be determined by the controller based on the temperature-monitor signal V_{T}.

The controller 28 also connects to the host system 15 via a serial port 43. The controller 28 receives commands and, by responding the commands, sends data regarding to the operation of the data link 10 via the serial port 43 to the host system 15. Such data sent to the host system 15 is typically the temperature-monitor signal V_{T} and the power-monitor signal V_{P}.

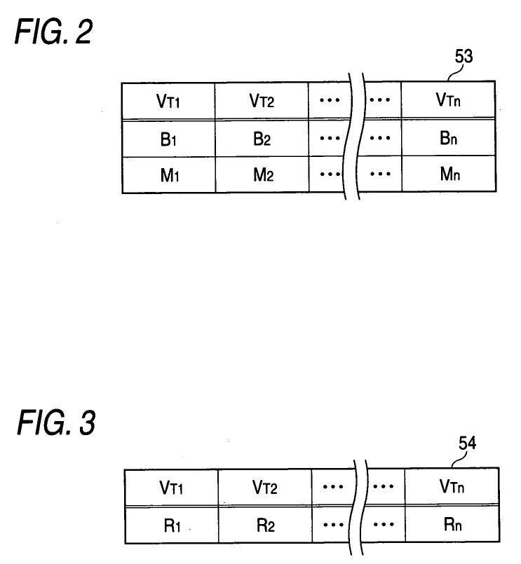

The controller 28 also provides a RAM 27 and a ROM 33. The RAM 27 is a primary memory for the controller 28 to execute the tasks such as the APC. The RAM 27 stores the power-monitor signal V_{P} and the temperature-monitor signal V_{T}, while the RCM 33 sets the LUT 53 illustrated in FIG. 2. The LUT 53 includes a plurality of paired digital values, B and M, each corresponding to the modulation I_{M} and bias I_{B} currents, respectively, in connection with various and different temperatures, V_{T1}, V_{T2}, . . . , V_{TN}. In FIG. 2, the bias and modulation levels, B and M, are subscripted with the same symbol as those or the temperatures from V_{T1} to V_{TN}, which indicate the inner temperature of the data link 10. The temperatures from V_{T3} to V_{TN} may set with a constant width, for instance 2° C. The paired values of the bias and modulation level, Bᵢ and Mᵢ, are defined such that, when the inner temperature of the data link 10 becomes the value V_{T1}, the data link 10 outputs the light O_{OUT} with a predefined average power and an extinction ratio as stopping the APC loop by supplying the bias and modulation currents, I_{B} and I_{M}, which corresponds to the bias and modulation levels, Bᵢ and Mᵢ.

The controller may further provide outer ROMs, 34 and 35, such as electrical erasable and programmable read only memory (EEPROM) that are re-writable from the controller 28. The first EEPROM 34 sets another LUT 54 illustrated in FIG. 3. The LUT 54 stores the resistance R₁, R₂, . . . R_{N} in connection with the temperatures V_{T1}, V_{T2}, . . . V_{TN}. These values from R₁ to R_{N} are defined such that, when the inner temperature of the data link 10 becomes the corresponding value Tᵢ and the bias and modulation levels, Bᵢ and Mᵢ, linked to the temperature Tᵢ are set, the power-monitor signal V_{P} becomes a prescribed value. As shown in later in the present specification, this prescribed value is served as a reference value V_{R} for the APC loop. The APC loop compares the power-monitor signal V_{P} with the reference value V_{R}, namely, with this prescribed value, and adjusts the bias and modulations currents, I_{B} and I_{M}, based on the comparison. The values or the resistance, R₁ to R_{N}, are measured at the delivery inspection in advance to the shipment.

The host system may instruct the controller 28 via the serial port 43 to write the data into the nonvolatile memories, from 33 to 35. The controller may behave as a memory controlling circuit to rewrite the nonvolatile memories, 33 to 35, by responding to the command from the host system 15.

Next, the operation of the data link 10 will be described. Starting the data link 10, the controller 28 sets the predefined initial temperature V_{TINT} in advance to the operation of the APC. The initial temperature V_{TINT} is one of the temperatures from V_{T1} to V_{TN} stored in the LUTs, 53 and 54, and the controller generally selects the room temperature, 25° C. The controller 28 reads out the bias and modulation levels, B_{INT} and M_{INT}, in connection with the initial temperature V_{TINT} from the LUT 53, and the initial resistance RIB from the LUT 54 Subsequently, the controller 28 adjusts the bias and modulation currents, I_{B} and I_{M}, according to the corresponding levels, B_{INT} and M_{INT}, and sets the resistance R_{INT} of the variable resistor 32.

Thus, two levels, B_{INT} and M_{INT}, and the resistance R_{INT} are read out from the LUTs, 53 and 54, for the data link 10 to show the predefined the average power and extinction ratio. The bias and modulation levels, and the resistance to maintain the extinction ratio of the data link 10 depend on the inner temperature of the data link 10. Accordingly, the bias and modulation levels and the resistance, by which the desired extinction ratio and the average power are set, are obtained in advance to the practical operation of the data link 10 at several temperatures and stores within the LUTs, 53 and 54. Selecting two levels, Bᵢ and Mᵢ, and the resistance Rᵢ from the LUTs, 53 and 54, corresponding to the preset temperature T_{INT}, the initial condition of the APC loop may be determined.

Subsequently, the controller 28 starts the APC loop and adjusts the bias and modulation levels to match the power-monitor signal V_{P} with the predefined reference value V_{R}. The APC loop is one type of a closed loop operation that compensates not only the temperature dependence of the LD 14 but also the temporal degradation thereof.

The APC loop by the controller 28 will be described in detail. The controller 28 adjusts the target temperature of the LD 14 based on the comparison between the power-monitor signal V_{P} and the reference value V_{R}. In one embodiment, the controller 28 may add the product of the difference between the power-monitor signal V_{P} and the reference value V_{R} multiplied by a specific co-efficient to the present target temperature. The controller 28 reads out the bias and modulation levels, Bⱼ and Mⱼ, and the resistance Rⱼ each corresponding to the revised target temperature Tⱼ from the LUTs, 53 and 54. Assuming the difference between the power-monitor signal V_{P} and the reference value V_{R} is [symbol] V, the specific co-efficient is k[T/V], and the present target temperature is Tᵢ, the revised target temperature Tⱼ becomes;
Tⱼ=kV+Tᵢ.
The controller 28 reads out the new bias and modulation levels, Bⱼ and Mⱼ, from the LUT 53 and the revised resistance Rⱼ from the LUT 54, each corresponds to the revised target temperature Tⱼ, and sets these readout values in respective D/A-Cs, 25, 26 and 32. When the interval of the temperatures set in the LUTs, 53 and 54, is rough or sparse such as 2° C., and the revised target temperature does not get on the temperatures in the LUTs, 53 and 54, it may be applicable to operate the APC loop by the bias and modulation levels and the resistance corresponding to a temperature closest to the target temperature Tⱼ, or to calculate the levels and the resistance by the interpolation or the extrapolation for the data in the LUTs, 53 and 54.

The controller 28 sets the revised bias level V_{Bj} and the revised modulation level V_{Mj} in the D/A-Cs, 25 and 26, respectively, and sets the revised resistance Rⱼ in the variable resistor 32. These levels, V_{Bj} and V_{Mj}, are provided to the LD-Driver 22 to adjust the bias and modulation currents, I_{B} and I_{M}, respectively. The signal Rⱼ sent from the controller 28 sets the resistance of the variable resistor 32 defines the conversion gain of the photo current within the APC loop.

When the power-monitor signal V_{P} is enough greater than the reference value V_{R}, the bias level smaller than the present bias level is selected from the LUT 53, while the power-monitor signal V_{P} is far smaller than the reference V_{R}, the bias level higher than the present level is selected. Thus, the optical output O_{OUT} from the data link 10 is stabilized. Since the pair of bias and modulation levels in the LUT 53 and the resistance in the LUT 54 are so set that not only the average optical output power but also the extinction ratio be substantially constant, the extinction ratio of the optical output O_{OUT} can be also stabilized.

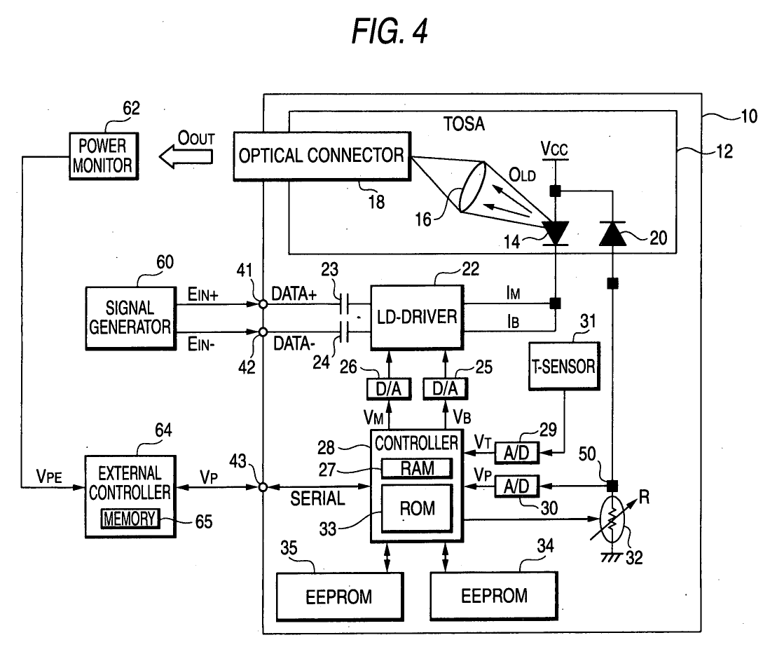

The data within the nonvolatile memory, 33 to 35, are set before the shipment of the data link 10 by the manufacturer. FIG. 4 shows a schematic configuration to set the data within the memories, 33 to 35. Using a signal generator 60, an optical power meter 62, and an external controller 64 may carry out the adjustment at the factory.

Two input terminals, 41 and 42, of the data link 10 are connected to the output of the signal generator 60 to receive two test signals, E_{IN+} and E_{IN-}, which may be, for example the pseudo random signals complementary to each other. The LD-Driver 22 drives the LD 14 based on this test signal to output the light O_{LD}. This light O_{LD} may couple to the optical connecter 18 via the optical coupling system 16.

The optical power meter 62, which is placed outside of the data link 10, is a type of an optical detector coupled with the optical connector 18. The power meter 62 receives the optical output O_{OUT} and generates an electrical signal V_{PE} corresponding to this optical output O_{OUT}. This signal V_{PE} is sent to the external controller 64. The PD 20 within the data link 10 detects the output O_{LD} directly from the LD 14, while the optical power meter 62 monitors the light O_{OUT} output through the optical connector 10.

The external controller 64 provides an interface connected to the serial port 43 of the data link 10 and a memory 65. This external controller 64 may send commands to the controller 28 of the data link 10 via the serial port 43 to adjust the bias and modulation levels and the resistance R. Also, the external controller 64 may start or stop the APC loop operated by the controller 28.

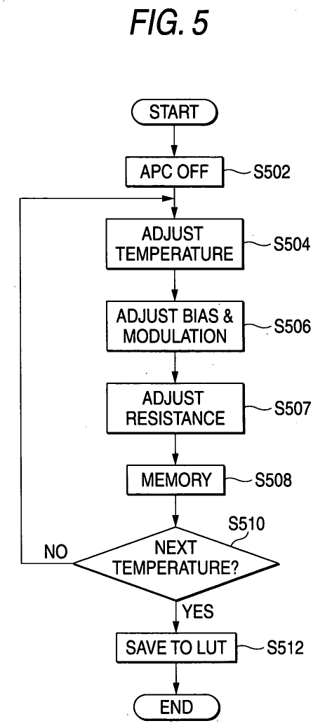

Next, the method for storing the paired data of the bias and modulation levels and the resistance into the LUTs, 53 and 54, will be described as referring to FIG. 5 that is a flow chart showing the procedure to get paired data of the bias and modulation levels.

The process shown in FIG. 5 obtains data necessary to operate the APC loop as the loop is halted. Specifically, the bias and modulation levels are so adjusted that, as the inner temperature of the data link 10 is sequentially set at the plurality of preset temperatures, the optical output O_{OUT} from the datalink shows the predetermined average power and extinction ratio under respective preset temperatures. As an example, the preset temperatures are 25, −10 and 60° C., respectively. As shown in FIG. 5, the external controller 64 stops the APC loop within the data link 10 as step S502, and the inner temperature is set to be one of these preset temperatures at step S504. During the inner temperature of the data link is adjusted, the external controller 64 receives the temperature-monitor signal V_{T} from the controller 28 within the data link 10 via the serial interface, and decides whether the inner temperature of the data link 10 becomes stable at the preset temperature.

Next, the external controller 64 adjusts the bias and modulation levels to obtain the predetermined average power and extinction ratio at step S506. In this step, the signal generator 60 outputs the test signal to the data link 10, and the data link 10 generates the optical output O_{OUT} based on this test signal. This optical output O_{OUT} is detected by the power meter 62, and the external controller 64, receiving from the result V_{PE} from the power meter 62, evaluates the average power and the extinction ratio of the optical output O_{OUT}, and adjusts the bias and modulation levels to match with the predetermined conditions.

Subsequently, the external controller 64 adjusts the resistance R of the variable resistor 32 at step s507 such that the output O_{LD} from the LD 14, which is detected by the PD 20, becomes the reference V_{R}. When the average power and extinction ratio of the optical output O_{OUT} from the data link 10 under the APC loop being halted, the optical output O_{LD} from the LD 14 does not always match with the reference V_{R} because the optical output O_{OUT} is affected by the temperature characteristic of the optical coupling system 16. This temperature dependence of the optical coupling system is generally called as the tracking error. When the power-monitor signal V_{P} shifts from the reference V_{R}, the APC loop operates to cancel this shift by adjusting the bias and modulation levels. Consequently, the average power and extinction ratio of the optical output O_{OUT} from the data link deviates from the predetermined value. To compensate this tracking error, the resistance R of the variable resistor 32 is adjusted to match the power-monitor signal V_{P}, which corresponds to the optical output O_{LD} from the LD 14, with the reference value V_{R} as the LD 14 is operated by the bias and modulation levels adjusted at the step S506.

Thus, the average power and extinction ratio of the optical output O_{OUT} of data link 10 matches with the predetermined conditions and the power-monitor signal V_{P} showing the optical output O_{LD} of the LD 14 matches with the reference value V_{R} through the sequence of steps from S502 to S506 at the preset temperature. However, the gain of the APC loop is changed because the resistance R of the variable resistor 32 is adjusted.

The bias and modulation levels and the resistance thus obtained are stored in the memory 65 in connection with the preset temperature V_{T} at step S508. Subsequently, the inner temperature of the data link 10 is set to the next preset temperature at step S504, another bias and modulation levels and another resistance are obtained by the same procedure described above at step S506, and thus obtained levels and resistance are stored in the memory 65 at step S508. The same procedure as those described above will be iterated until the preset temperatures are exhausted at step S510.

Completing the adjustment of the bias and modulation levels and the resistance under the whole preset temperatures, the paired bias and modulation levels and the resistance obtained through the adjustments above are sent to the nonvolatile memory within the data link 10 to build the LUTs, 53 and 54. In the present embodiment, the extrapolation or the interpolation of the data stored in the memory 65 may create a plurality of new set of the data at temperatures different to the prescribed one. Thus, the plurality paired bias and modulation levels, B₁ to Bₙ and M₁ to Mₙ, respectively, and the plurality of resistance, R₁ to Rₙ, are may be obtained in connection with the plurality of the inner temperatures of the data link 10. These sets of the paired bias and modulation levels, Bᵢ and Mᵢ, and the resistance Rᵢ controls the average power and the extinction ratio of the optical output O_{OUT} at the inner temperature Tᵢ of the data link 10. The external controller 64 creates the first LUT 53 where the paired bias and modulation levels are set in connection with the temperature, and the second LUT 54 where the resistance is set in connection with the temperature. The controller 64 transfers these LUTs to the controller 28 via the serial port 43, and sends a command to the controller 28 to write the LUTs, 53 and 54, onto the nonvolatile memories, 33 and 34, respectively. Although the present embodiment constructs two LUTs in the independent memories, 33 and 34, the bias levels, B₁ to Bₙ, the modulation levels, M₁ to Mₙ, and the resistance, R₁ to Rₙ, may be gathered in connection with the temperatures, T₁ to Tₙ, within the signal LUT.

Although the present invention has been thus described based on the embodiment and accompanying drawings, the present invention is not restricted to those embodiments. For example, although two LUTs store the data in connection to the same temperatures, each LUT does not always refer the same temperatures. Moreover, the embodiment concentrates on the data link having only the optical transmitting function. The function of the present invention may apply to the optical transceiver that provides not only the optical transmitting function but also the optical receiving function.

Although the embodiment above described selects one pair of the bias and modulation levels in the LUT 53, the various method to select these two levels may be applicable to the present invention. For example, the controller 28 may set the revised bias and modulation levels corresponding to the revised temperature by the interpolation or the extrapolation of the data stored in the LUT 53. Even such method is applied to set the revised condition, the optical output O_{OUT} from the data link 10 may maintain the predetermined average power and the extinction ration, because the entire data in the LUT 53 gives the predetermined conditions.

What is claimed is:

1. A method for controlling an optical output of an optical data link that comprises
a laser diode for emitting light,
an optical coupling system for guiding said light to an outside of said data link,
a photodiode for monitoring said light, and
a controller constituting an auto-power-control loop co-operating with said laser diode and said photodiode, said controller including a control look-up-table that stores a plurality of information to make an average power and an extinction ratio of an optical output of said data link constant and a plurality of information to adjust loop gain of said auto-power-control against temperatures of said data link, said method comprising steps of
a) setting a target temperature in said controller;
b) reading said information to make an average power and an extinction ratio constant from said look-up-table and setting a current to be supplied to said laser diode by said controller based on said information;
c) reading said information to adjust said loop gain of said auto-power-control loop and setting said loop gain by said controller; and
d) starting said auto-power-control loop.

2. The method according to claim 1,
wherein said auto-power-control loop including steps of:
comparing an average power of said light emitted from said laser diode with a reference value and revising said target temperature by adding a temperature difference derived from said comparison multiplied by a specific coefficient to said target temperature,
reading new information to make said average power and said extinction ratio constant and to adjust said loop gain of said auto-power-control loop from said look-up-table based on said revised target temperature, and
setting revised current supplied to said laser diode and revised loop gain by said controller.

3. The method according to claim 2,
wherein said new information read by said controller from said look-up-table is calculated by an extrapolation or an interpolation of said plurality of information stored in said look-up-table.

4. The method according to claim 1,
wherein said information to make said average power and said extinction ratio constant includes a bias current and a modulation current to be supplied to said laser diode.

5. The method according to claim 1,
wherein said setting of said loop gain is carried out by setting a conversion efficiency of a photo current to a voltage signal, said photo current being generated by said photodiode and corresponding to said average power of said light emitted from said laser diode.

6. The method according to claim 5,
wherein said setting of said conversion efficiency is carried out by setting resistance of a load resistor of said photodiode.

7. A method for manufacturing an optical data link that comprises
a laser diode for emitting light,
an optical coupling system for guiding said light to an outside of said data link,
a photodiode for monitoring said light and generating a power-monitor signal corresponding to an average power of said light with a conversion ratio, and
a controller constituting an auto-power-control loop co-operating with said laser diode and said photodiode, said controller including a control look-up-table that stores a plurality of information to make an average power and an extinction ratio of an optical output of said datalink constant and a plurality of information to adjust loop gain of said auto-power-control against temperatures of said data link, said method comprising steps of:
a) shutting said auto-power-control off and setting an ambient temperature of said data link to a preset temperature;
b) under said ambient temperature, setting a bias current and a modulation current such that said optical output of said data link shows a predetermined average power and a predetermined extinction ratio;
c) under said ambient temperature and said bias and modulation currents, setting said conversion ratio of said photodiode to match said average power of said light with a reference value; and
d) iterating said processes (b) and (c) as changing said preset temperature; and
e) creating said look-up-table by arranging said bias and modulation currents and said conversion ratio against said preset temperatures.

8. The method according to claim 7,
wherein said creation of said look-up-table includes an extrapolation and an interpolation of said bias and modulation currents and said conversion ratio against said preset temperatures to subdivide an interval of said preset temperatures.

9. The method according to claim 7,
wherein said optical coupling system includes a lens to concentrate said light emitted from said laser diode.

10. The method according to claim 7,
wherein said adjustment of said conversion ratio of said photodiode is carried out by changing resistance of a load resistor of said photodiode.

11. An optical data link, comprising:
a semiconductor laser diode for emitting light;
an optical coupling system for guiding said light emitted from said laser diode to an outside of said optical data link;
a photodiode for monitoring an average power of said light emitted; and
a controller constituting an auto-power-control loop cooperating with said laser diode and said photodiode, said controller including a control look-up-table that saves a plurality of paired data of bias and modulation currents to make an average power and an extinction ratio of an optical output from said data link constant and a plurality of information relating to said auto-power-control loop to adjust loop gain of said auto-power-control in connection with temperatures of said data link.

12. The optical data link according to claim 11,
wherein said optical coupling system includes a lens to concentrate said light emitted from said laser diode.

13. The optical data link according to claim 11,
wherein said information to make said average power and said extinction ratio of said optical output of said data link constant is a bias current and a modulation current supplied to said laser diode, and said information to adjust loop gain is a resistance or a load resistor of said photodiode.
